(19) United States
(12) Patent Application Publication
(10) Pub. No.: US 2025/0334457 A1
(43) Pub. Date: Oct. 30, 2025

(54) METHOD AND APPARATUS FOR SENSING THERMAL RADIATION FLUX

(71) Applicant: New Mexico Tech University Research Park Corporation, Socorro, NM (US)

(72) Inventor: Michael Hargather, Socorro, NM (US)

(21) Appl. No.: 19/187,820

(22) Filed: Apr. 23, 2025

Related U.S. Application Data
(60) Provisional application No. 63/638,234, filed on Apr. 24, 2024.

(51) Int. Cl. G01K 17/00; G01J 5/00; G01K 7/04

(52) U.S. Cl. CPC G01K 17/00; G01J 5/0003; G01K 7/04

(57) ABSTRACT

A method and apparatus for sensing thermal radiation flux are disclosed. A first layer includes a first outer surface and a first inner surface. The first outer surface receives incident thermal radiation and the first inner surface emits transmitted thermal radiation. A second layer is spaced apart from the first layer and includes a second inner surface that faces the first inner surface and receives the transmitted thermal radiation. A vacuum layer is positioned between the first layer and second layer. A first sensor collects first thermal data including a first thermal measurement of the first inner surface. A second sensor collects second thermal data including a second thermal measurement of the second inner surface. A controller is configured to determine a thermal radiation flux of the transmitted thermal radiation based on, at least in part, a comparison of the first thermal data and the second thermal data.

### CROSS-REFERENCE TO RELATED APPLICATION

This application claims the benefit of U.S. Patent Application Ser. No. 63/638,234, filed on Apr. 24, 2024, which is incorporated herein by reference in its entirety.

### TECHNICAL FIELD

This disclosure generally relates to a method and apparatus for sensing thermal radiation flux through the measurement of temperature of two surfaces separated by a known medium.

### BACKGROUND

Spacecraft in orbit experience periodic thermal cycling naturally, and they are designed to accommodate these thermal loads. However, advancements in the thermal imaging technology implemented on spacecraft and/or in other industries has been limited. For instance, most spacecraft currently use methods for temperature measurement, such as thermocouples or fiber optic sensors, that do not provide multi-dimensional spatial resolution.

In turn, such arrangements for thermal monitoring may be unable to provide a two-dimensional thermal map across a surface of a spacecraft and/or other object. Moreover, such arrangements may be unable to isolate the types of heat transfer that are being exposed to those surfaces of an aircraft. For instance, such arrangements may be unable to identify the thermal flux that is a result of radiation, as opposed to conduction and/or convection.

### SUMMARY

Embodiments of the present invention relate to a method and apparatus for sensing radiation heat transfer fluxes using temperature measurement on two surfaces separated by a known medium. By measuring the temperature on each side of the medium, the conduction flux can also be measured. In one example embodiment, two plates are used to form two surfaces separated by a vacuum. The first plate receives the incident radiation. The second plate is separated from the first plate by the vacuum, and the second plate is referred to as the receiving plate. The vacuum between the two plates will allow only radiation transfer. In this example, when an incident radiation impacts the first plate, which is a thin film to allow rapid conduction through, it is then re-radiated from the back side of the plate toward a receiving plate. The temperature on the two surfaces is measured for example, optically using a thermal imaging camera to allow a spatial resolution of the heat transfer. With a measurement of temperature on each surface, the radiative flux can be calculated. Other examples may include other materials and other methods of measuring temperature.

Objects, advantages and novel features, and further scope of applicability of the present invention will be set forth in part in the detailed description to follow, taken in conjunction with the accompanying drawing, and in part will become apparent to those skilled in the art upon examination of the following, or may be learned by practice of the invention.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention.

FIG. 1 is a diagram which illustrates an assembly for measuring thermal radiation according to an embodiment of the present disclosure.

FIG. 2 is a diagram which further depicts a schematical representation of an embodiment of layers of the assembly of FIG. 1.

FIG. 3 is a diagram which further depicts a schematical representation of an alternative embodiment of layers of the assembly of FIG. 1.

FIG. 4 is a block diagram of electronic components of the assembly of FIG. 1.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, terms, “a”, “an”, “the”, and “said” mean “one or more” unless context explicitly dictates otherwise. Note that in the specification and claims, “about”, “approximately”, and/or “substantially” means within twenty percent (20%) of the amount, value, or condition given.

Various embodiments of the present disclosure relate to a method and apparatus for sensing radiation heat transfer fluxes using temperature measurement on two surfaces separated by a known medium (e.g., a vacuum). Specifically, various embodiments of the present disclosure include two plates-a first plate that receives an incident radiation, and a second plate that is separated from the first plate by the known medium. When an incident radiation impacts the first plate, it is then re-radiated from the back side of the plate towards the second, receiving plate. The temperature on the two surfaces adjacent to the known medium is measured. With a measurement of temperature on each surface, the radiative flux can be calculated. As explained in greater detail below, advantages of this method and apparatus include the simple construction and wide applicability.

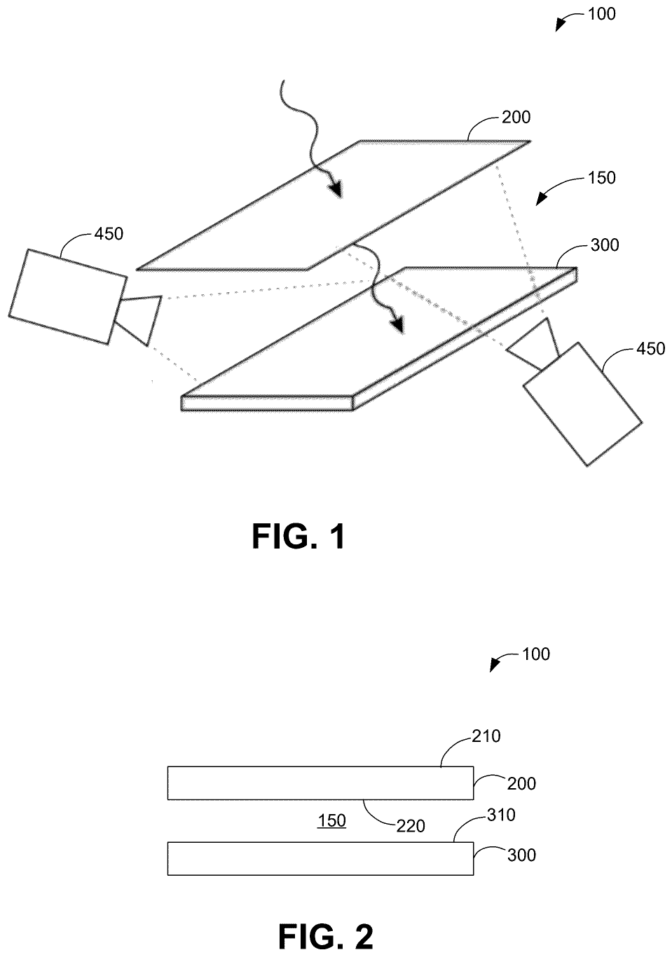

FIG. 1 illustrates one example embodiment of the present disclosure. As depicted in FIG. 1, a flux measurement assembly 100 includes two outer layers 200, 300 that are spaced apart from each and separated by a middle layer 150 of a known medium. The outer layer 200 (also referred to as a “first layer,” a “first outer layer,” an “incident layer,” and a “transmitting layer”) is configured to receive incident thermal radiation from a source and, in turn, emit transmitted thermal radiation through the middle layer 150 and to the outer layer 300. The outer layer 300 (also referred to as a “second layer,” a “second outer layer,” and a “receiving layer”) is separated from the layer 300 by the middle layer 150 and configured to receive the transmitted thermal radiation from the outer layer 200.

As further illustrated in FIG. 2, the outer layer 200 includes an outer surface 210 and an inner surface 220. The outer surface 210 (also referred to as a “first outer surface” and an “incident surface”) is configured to receive the incident thermal radiation from a source. That is, as shown in FIG. 1, the flux measurement assembly 100 is configured to be positioned such that the outer surface 210 of the outer layer 200 receives the incident thermal radiation. Upon the outer surface 210 receiving the incident thermal radiation, heat then conducts through a thickness of the outer surface 210 and is emitted from the inner surface 220 (also referred to as a “first inner surface” and a “transmitting surface”) as thermal radiation. That is, the inner surface 220 is configured to emit transmitted thermal radiation.

The outer layer 300 includes an inner surface 310 (also referred to as a “second inner surface” and a “receiving surface”) that is configured to receive the transmitted thermal radiation from the inner surface 220 of the outer layer 200. As shown in FIG. 2, the outer layers 200, 300 are arranged such that the inner surface 310 of the outer layer 300 faces the inner surface 220 of the outer layer 200. In the illustrated example, the outer layers 200, 300 extend parallel to each other. As disclosed below in further detail, the middle layer 150 is positioned between the inner surface 220, 310 such that the transmitted thermal radiation that is emitted from the inner surface 220 travels through the middle layer 150 before being received by the inner surface 310.

In the illustrated example, each of the outer layers 200, 300 is plate-shaped. It should be appreciated that the term “plate” refers to a variety of materials. For example, in one embodiment, one or both of the outer layers 200, 300 can be made of a thick material, such as a metal plate. In certain alternative embodiments, one or both of the outer layers 200, 300 are preferably made thin—for example as a thin film. In one embodiment, at least the outer layer 200 is preferably formed from a thermally conductive material, for example, a metal material. Additionally, the outer layer 300 may be formed from a thermally conductive material, such as a metal material. The outer layer 200 is a transmitting layer that is arranged to receive the incident thermal radiation, conducts heat to its other side, and then emits transmitted thermal radiation to the outer layer 300. The outer layer 300 is a receiving layer that receives the transmitted thermal radiation from the outer layer 200. In one embodiment, one or both of the outer layers 200, 300 is a film layer that is preferably formed from a metal, which can include, for example, gold leaf or a thin silver film. Optionally, the inner surface 220 of the outer layer 200 and/or the inner surface 310 of the outer layer 300 can be coated with a material or colorant to increase and/or otherwise improve emissivity of the respective outer layer 200, 300. In one embodiment, the thickness of the outer layer 200 is preferably less than about 1 millimeters (“mm”) and more preferably less than about 0.1 mm and most preferably less than about 0.01 mm. In one embodiment, the outer layer 200 is preferably at least substantially parallel with the outer layer 300. Further, in one embodiment, the outer layer 200 may include a grid formed of a first material and a second material. In such an embodiment, the first material is formed of a thermally-conductive material and forms cells in the grid, and the second material is formed of thermally-insulative materials and forms gridlines of the grid. Such a grid of thermally-conductive material and thermally-insulative material is configured to facilitate thermal monitoring of the inner layer 220, for example, in two dimensions.

Turning next to the middle layer 150, it is formed of a known medium and separates the outer layers 200, 300. In this example, the middle layer 150 extends between and abuts the outer layers 200, 300. Further, the medium that forms the middle layer 150 in the illustrated example is a vacuum that only permits heat transfer between the outer layers 200, 300 via thermal radiation and prevents heat transfer via conduction and/or convection. In turn, by having the middle layer 150 be a vacuum layer, the flux measure assembly 100 is able to accurately measure the thermal flux between without suffering degradation in performance due to conduction between the outer layers 200, 300.

In certain embodiments, the distance between the inner surface 220 of the outer layer 200 and the inner surface 310 of the outer layer 300 (i.e., the thickness of the middle layer 150) may range from 10 cm to 1 cm. In other embodiments, the distance may be much larger, such as for example greater than 1 meter. For example, with applications in outer space, the separation could be wider with open vacuum of space in between.

In each embodiment, the layers 150, 200, 300 of the flux measurement assembly are arranged such that the distance between the outer layers 200, 300 accommodates the imaging or measurement of the inner surfaces 220, 310 and/or the outer layers 200, 300, as described in greater detail below. As the distance between the inner surfaces 220, 310 decreases, the spatial resolution of the heat flux may be increased.

In embodiments in which the middle layer 150 is a vacuum layer, the vacuum is sufficient to limit heat conduction and/or convection between the outer layers 200, 300. For example, the vacuum formed in the middle layer 150 such that the radiation flux is at least one order of magnitude larger than the convection and/or conduction that can occur between the outer layers 200, 300. In some such examples, the vacuum level may be similar to what is used in residential windows (e.g., vacuum-spaced window panes). The vacuum levels in other commercial type applications, like vacuum coffee mugs or thermoses, may also be appropriate for the middle layer 150.

Turning to FIG. 4, a block diagram of certain electronics of the flux measurement assembly 100 are depicted. In the illustrated example, the electronics include a controller 525, a sensor 400, and a sensor 450.

The controller 525 includes a processor 550 and memory 575. One or more of the electronics, such as the controller 525, the processor 550, the memory 575, the sensor 400 and/or the sensor 450, may be housed on a printed circuit board (PCB). That is, the flux measurement assembly 100 may include a PCB on which the controller 525, the processor 550, the memory 575, the sensor 400 and/or the sensor 450 are mounted. Further, in some embodiments, the controller 525, the processor 550, and/or the memory 575 may be integrally formed as a single unit, with or without one or more of the sensors 400, 450.

The processor 550 may be any suitable processing device or set of processing devices such as, but not limited to, a microprocessor, a microcontroller-based platform, an integrated circuit, etc. The memory 575 may include one or more of volatile memory, non-volatile memory, read-only memory, etc. In some examples, the memory 575 may include a combination of multiple kinds of memory, such as volatile memory and non-volatile memory. The memory 575 is computer readable media on which one or more sets of instructions, such as the software for operating the methods of the instant disclosure, can be embedded. The instructions may embody one or more of the methods or logic as described herein. For example, the instructions reside completely, or at least partially, within any one or more of the memory 575, the computer readable medium, and/or within the processor 550 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

Returning briefly to FIG. 1, the sensor 400 (also referred to as a “first sensor” and a “thermal transmitting sensor”) is configured to collect thermal data (also referred to as a “first thermal data” and a “thermal transmitting data”) that is indicative of a temperature measurement (also referred to as a “first temperature” and a “transmitting temperature”) and/or a thermal map (also referred to as a “first thermal map” and a “thermal transmitting map”) of the inner surface 220 of the outer layer 200. Likewise, the sensor 450 (also referred to as a “second sensor” and a “thermal receiving sensor”) is configured to collect thermal data (also referred to as a “second thermal data” and a “thermal receiving data”) that is indicative of a temperature measurement (also referred to as a “second temperature” and a “receiving temperature”) and/or a thermal map (also referred to as a “second thermal map” and a “thermal receiving map”) of the inner surface 310 of the outer layer 300. That is, the sensor 400 is positioned and arranged to monitor the thermal radiation transmitted from the inner surface 220 of the outer layer 200, and the sensor 450 is positioned and arranged to monitor the thermal radiation received by the inner surface 310 of the outer layer 300.

In certain embodiments, the sensors 400, 450 are thermal imaging cameras that are capable of collecting data associated with two-dimensional thermal maps. The controller 525 of such embodiments is capable of identifying changes in a thermal radiation flux between the outer layers 200, 300 over time. In other certain embodiments, each sensor 400, 450 is a network of thermocouples that are mounted to the inner surface 220, 310 of the respective outer layer 200, 300. That is, the sensor 400 includes a first network of thermocouples positioned along the inner surface 220, and the sensor 400 includes a second network of thermocouples positioned along the inner surface 310. In such embodiments, the thermocouples of each respective sensor 400, 450 are arranged in a grid, with each thermocouple collecting local thermal data of a designated location along the respective inner surface 220, 310. Further, in certain embodiments, the sensors 400, 450 are time-resolved thermal imaging cameras The controller 525 of such embodiments is capable of generating a two-dimensional spatial resolution of the thermal resolution flux between the outer layers 200, 300.

The controller 525 is configured to determine a thermal radiation flux of thermal radiation transmitted between the outer layers 200, 300. To determine the radiative flux, the controller 525 is configured to collect the thermal data associated with the outer layer 200 from the sensor 400 and collect the thermal data associated with the outer layer 300 from the sensor 450. The controller 525 is configured to then determine the thermal radiation flux based on, at least in part, a comparison (e.g., a difference) between the two sets of thermal data. That is, by measuring the temperature of and/or collecting thermal map data for each side of a vacuum layer (e.g., the middle layer 150) via the respective sensors 400, 450, the controller 525 is able to measure thermal radiation flux. In some examples, the controller 525 is further configured to generate a thermal flux map (e.g., a 2-dimensional map) that is representative of the thermal radiation flux.

The sensors 400, 450 are preferably thermal imaging cameras to optically measure temperatures along the respective inner surfaces 220, 310 to enable the controller 525 to generate a spatial resolution of the heat transfer. And, the sensors 400, 450 measuring the temperature optically enables the sensors 400, 450 to be constructed and operate such that the sensors 400, 450 do not have thermal or electrical connections to either the outer layers 200, 300. The avoidance of such connections means that (1) the sensors 400, 450 are not subject to performance degradation by conduction through such connections, (2) penetrations in the vacuum seal do not need to be provided, and (3) changes in temperature are detectable much more quickly.

In an alternative embodiment, the controller 525 may use a different calculation method for the thermal radiation flux. In such an embodiment, the controller 525 uses a known heat transfer boundary condition to improve the measurement of thermal radiation flux associated with the thermal radiation transmitted from the outer layer 200. In an example of this alternative embodiment, an outer surface of the outer layer 300 may be maintained with a known heat transfer boundary condition. For example, the outer layer 300 may have an insulated outer surface (also referred to a “rear surface”). In other alternative embodiments, the outer layer 300 may be open to the ambient atmosphere (or vacuum of space), maintained to allow a constant radiative flux through the outer layer 300, or maintained at a constant temperature through external means. These different conditions create a known heat transfer boundary condition at the outer layer 300 and improve measurement of thermal radiation flux.

As illustrated in FIG. 1, the incident radiation thermal impacts the outer surface 210 of the outer layer 200. The outer layer 200 is preferably thin and allows rapid conduction of heat through it, with the heat then being re-radiated from the inner surface 220 of the outer layer 200, through a vacuum (or at least a partial vacuum) of the middle layer 150, and to the inner surface 310 of the outer layer 300. With a respective measurement of temperature and/or a thermal map on the inner surface 220 of the outer layer 200 and the inner surface 310 of the outer layer 300 (i.e., the surfaces adjacent to the vacuum of the middle layer 150 therebetween), the controller 525 is preferably calculated using the formula of Equation 1:

$${q}_{12} = \frac{A σ ( {T}_{1}^{4} - {T}_{2}^{4} )}{\frac{1}{{ε}_{1}} + \frac{1}{{ε}_{2}} - 1} \qquad Equation 1$$

In Equation 1, q₁₂ represents the thermal radiation flux, A represents the surface area of both the inner surface 220 monitored by the sensor 400 and the inner surface 310 monitored by the sensor 450, σ represents the Stefan-Boltzmann constant, T₁ represents the measured temperature of the inner surface 220, T₂ represents the measured temperature of the inner surface 310, ε₁ represents the emissivity of the inner surface 220 of the outer layer 200, and ε₂ represents the emissivity of the inner surface 310 of the outer layer 300. Further, F₁₂ equals ‘1’ and represents a view factor form the inner surface 220 to the inner surface 310.

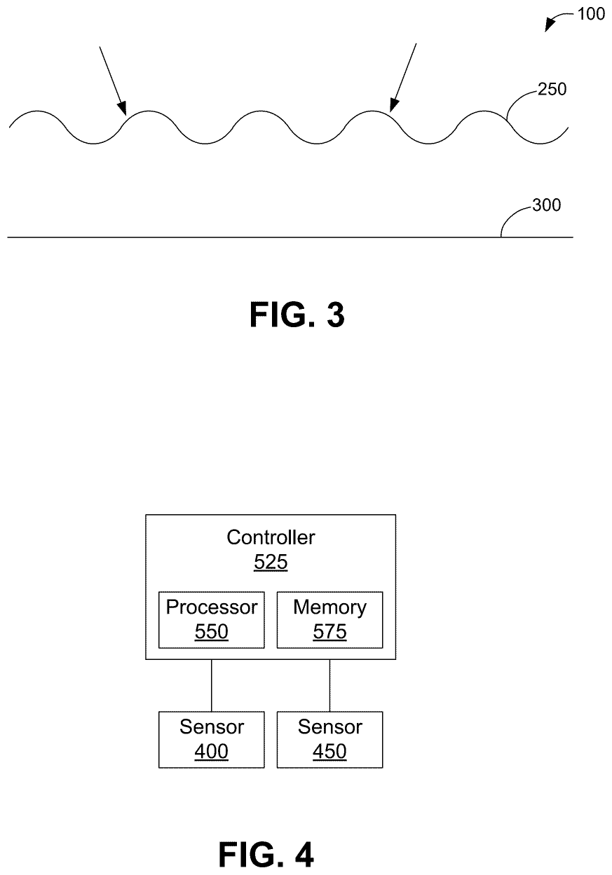

Turning to FIG. 3, the flux measurement assembly includes an alternative embodiment of a transmitting layer 250 (also referred to as an “outer layer,” a “first layer,” a “first outer layer,” and an “incident layer”). The outer layer 250 may comprise a different shaped surface that enables the outer layer 250 to be used to detect the direction of incident radiation. That is, the shape of the outer layer 250 may enable the controller 525 to detect a direction at which the incident radiation impacts the outer layer 250. This enables the controller 525 to determine where the radiation is coming from and/or measure the magnitude of the radiation. In the illustrated example, the outer layer 250 may have a wavy, dimpled, and/or otherwise textured shape and/or surface. In such an example, the wavy and/or dimpled surface of the outer layer 250 includes portions that face different directions from one another. The relative surface normal vector points to the direction that the most radiation would be coming from. Accordingly, the controller 525 is able to identify a surface variation of the temperature map on the wavy surface that shows the direction of incident radiation. In some embodiments, the controller 525 may use pattern matching algorithm(s) and/or machine learning system(s) to compare and/or otherwise analyze the thermal data collected from the inner layers 220, 310. For example, the controller 525 may use a machine learning system with a prototype to apply heat fluxes from different directions, measure the patterns, and then change the angle of the heat flux to generate a new pattern. The controller 525 may use the machine learning system, or other artificial intelligence algorithm, to interpret the measured surface temperature map to identify the direction of the heat flux.

It should further be appreciated that in certain embodiments, the use of a very thin film and time-resolved camera imaging can provide temporal resolution to the radiation flux. Such an embodiment can allow measurement of radiation variation. Embodiments of the present invention can be used as a flux variation measurement because the entire system can come to thermal equilibrium and therefore can optionally be used to only identify radiation changes. Even in thermal equilibrium, however, the present invention can continue to allow for quantification of fluctuations in radiation heat transfer.

Embodiments of the present invention are not only useful for terrestrial uses, but can be particularly useful for space applications for identifying or quantifying radiation impact on spacecraft or satellites. For flux variation measurements, embodiments of the present invention can be useful for warning detection for solar flares or other sporadic radiation impacts.

Embodiments of the present invention can provide a new method to measure thermal radiation magnitude, fluctuations, and direction on the surface of the spacecraft. The transient thermal radiation images can be used for condition monitoring for the spacecraft and to study space weather conditions.

Various embodiments of the present disclosure may be provided in different constructions and/or packaging. For example, one embodiment of the flux measurement assembly of the present disclosure could be packaged into a consolidated configuration with the external surface exposed and all cameras and detection equipment mounted inside. Such an embodiment may include sensors inside a package, like a small cube-sat, where one side of the cube sat would be the main detector surface. In such an embodiment, each surface of the cube sat could be a detection surface. The flux measurement assembly could thus be freely deployed as a cube-sat, attached to a platform like the International Space Station, mounted on another satellite, or mounted on a space vehicle. The flux measurement assembly could be used in terrestrial applications mounted on a platform that could be stationary or mobile, or may be field deployable. The flux measurement assembly could be large and have panels the size of large solar panels to provide larger radiation measurement.

Although the invention has been described in detail with particular reference to the disclosed embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

What is claimed is:

1. A system for measuring thermal radiation flux, the system comprising:
a first layer including a first outer surface and a first inner surface, wherein the first outer surface is configured to receive incident thermal radiation from a source and the first inner surface is configured to emit transmitted thermal radiation;
a second layer spaced apart from the first layer, wherein the second layer includes a second inner surface that faces the first inner surface and is configured to receive the transmitted thermal radiation;
a vacuum layer positioned between the first layer and second layer and through which the transmitted thermal radiation is to travel;
a first sensor configured to collect first thermal data including a first thermal measurement of the first inner surface of the first layer;
a second sensor configured to collect second thermal data including a second thermal measurement of the second inner surface of the second layer; and
a controller comprising a processor and memory, wherein the controller is configured to determine a thermal radiation flux of the transmitted thermal radiation based on, at least in part, a comparison of the first thermal data and the second thermal data.

2. The system of claim 1, wherein the first layer and the second layer extend parallel to each other.

3. The system of claim 1, wherein the vacuum layer extends between and abuts the first layer and the second layer.

4. The system of claim 1, wherein each of the first sensor and the second sensor is a respective thermal imaging camera.

5. The system of claim 1, wherein each of the first sensor and the second sensor is a respective time-resolved camera, and wherein the controller is further configured to determine changes in the thermal radiation flux over time.

6. The system of claim 1, wherein the first sensor includes a first network of thermocouples positioned along the first inner surface and the second sensor includes a second network of thermocouples positioned along the second inner surface.

7. The system of claim 1, wherein the comparison of the first thermal data and the second thermal data includes a calculation of a difference between the first thermal data and the second thermal data.

8. The system of claim 1, wherein the controller is configured to generate a thermal flux map indicative of the thermal radiation flux.

9. The system of claim 1, wherein each of the first thermal data and the second thermal data includes a respective two-dimensional map of thermal measurements, and wherein the controller is configured to generate a two-dimensional spatial resolution of the thermal radiation flux.

10. The system of claim 1, wherein the first layer includes a grid of a first material and a second material, wherein the first material is formed of a thermally-conductive material and forms cells in the grid, wherein the second material is formed of thermally-insulative materials and forms gridlines of the grid, wherein the grid of thermally-conductive material and thermally-insulative material is configured to facilitate thermal monitoring of the first inner surface in two dimensions.

11. The system of claim 1, wherein the first layer is a film layer.

12. The system of claim 1, wherein the first layer is a film of gold leaf or silver.

13. The system of claim 1, wherein at least one of the first inner surface or the second inner surface is coated with at least one or a material or a colorant to increase emissivity.

14. The system of claim 1, wherein the first layer is at least one of dimpled or wavy, and wherein the controller is configured to detect a direction of the incident thermal radiation at least partially based on patterns in the first thermal data that are caused by the first layer being at least one of dimpled or wavy.

15. A method for measuring thermal radiation flux, the method comprising:
positioning a flux measurement assembly relative to a source of incident thermal radiation, wherein the flux measurement assembly includes a first layer, a second layer, and a vacuum layer, wherein the first layer includes a first outer surface and a first inner surface, wherein the second layer is spaced apart from and extends parallel to the first layer and includes a second inner surface that faces the first inner surface;
receiving the incident thermal radiation via the first outer surface of the first layer;
collecting, via a first sensor, first thermal data including a first thermal measurement of the first inner surface of the first layer;
receiving, via the second inner surface of the second layer, transmitted thermal radiation that was emitted from the first inner surface of the first layer and traveled through the vacuum layer;
collecting, via a second sensor, second thermal data including a second thermal measurement of the second inner surface of the second layer; and
determining, via a controller comprising a processor and memory, a thermal radiation flux of the transmitted thermal radiation based on, at least in part, by comparing the first thermal data and the second thermal data.

16. The method of claim 15, wherein each of the first sensor and the second sensor is a respective time-resolved camera, and further comprising determining, via the controller, changes in the thermal radiation flux over time.

17. The method of claim 15, wherein comparing the first thermal data and the second thermal data to measure the thermal radiation flux includes calculating a difference between the first thermal data and the second thermal data.

18. The method of claim 15, wherein determining the thermal radiation flux of the transmitted thermal radiation includes utilizing at least one of a pattern matching algorithm or a machine learning method to compare the first thermal data and the second thermal data.

19. The method of claim 15, wherein each of the first thermal data and the second thermal data includes a respective two-dimensional map of thermal measurements, and further comprising generating, via the controller, a two-dimensional spatial resolution of the thermal radiation flux.

20. The method of claim 15, wherein the first layer is at least one of dimpled or wavy and further comprising detecting, via the processor, a direction of the incident thermal radiation at least partially based on patterns in the first thermal data that are caused by the first layer being at least one of dimpled or wavy.
